(19) United States
(12) Patent Application Publication
(10) Pub. No.: US 2011/0050063 A1
(43) Pub. Date: Mar. 3, 2011

(54) ADJUSTABLE TABLE STAND AND DEVICE USING THE SAME

(75) Inventors: MAN-ZHONG WANG, Shenzhen City (CN); SHI-PEI ZHANG, Shenzhen City (CN); TE-HUA LEE, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/821,337

(22) Filed: Jun. 23, 2010

(30) Foreign Application Priority Data
Aug. 26, 2009 (CN) 200910306113.3

(51) Int. Cl. A47B 95/00; F16M 13/00

(52) U.S. Cl. 312/351.1; 248/351

(57) ABSTRACT

A device includes a main body and a table stand connected to the main body for supporting the main body. The main body comprises a receiving portion and a plurality of locking grooves. The table stand received in the receiving portion comprises a retaining board and a turning board. The retaining board is operable to be selectively inserted into one of the locking grooves, such that the retaining board and turning board are capable to form different angles to place the main body at different viewing angles.

### BACKGROUND

1. Technical Field

The present disclosure relates to devices, and particularly to a device with a table stand which is adjustable to select a desirable viewing angle.

2. Description of Related Art

Some devices are equipped with a support such as a table stand that swivels out from the device to support the device on a flat surface. However, most current table stands are not adjustable or not easily adjustable, and the table stands fold out at a predetermined angle with the device. As a result, the viewing angle for different users cannot be adjusted.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of a device having an adjustable table stand. Moreover, in the drawings, like reference numerals designate corresponding parts throughout several views.

FIG. 1 is an assembled, isometric, schematic view of a device having an adjustable table stand in an open state, according to an exemplary embodiment.

FIG. 2 is an exploded view of the device of FIG. 1.

FIG. 3 is similar to FIG. 1, but showing the table stand of the device in another open state.

FIG. 4 is similar to FIG. 3, but showing the table stand of the device in a closed state.

### DETAILED DESCRIPTION

Embodiments of the present disclosure will now be described in detail with reference to the drawings.

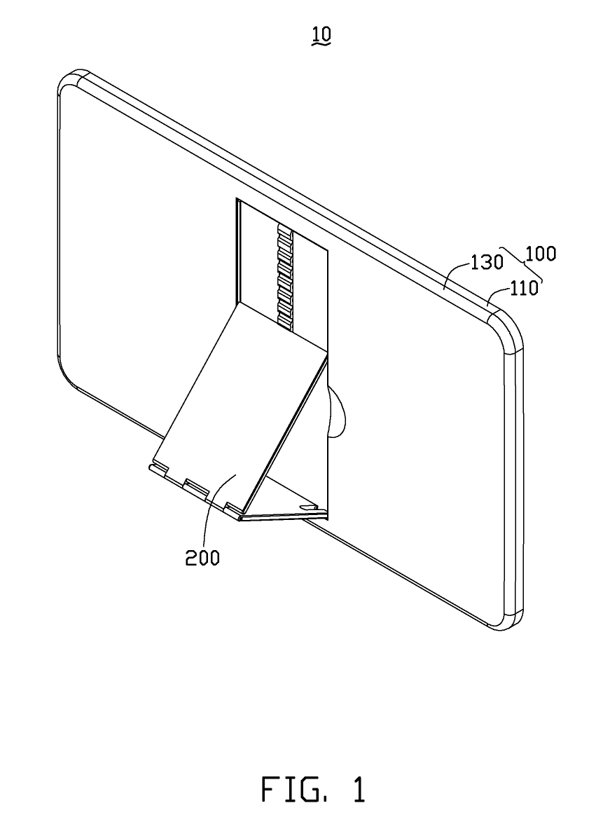

Referring to FIG. 1, a device 10 includes a main body 100 and a table stand 200 connected to the main body 100. The main body 100 includes a front housing 110 with a display panel (not shown) and a rear housing 130 engaged with the front housing 110. In this embodiment, the device 10 may be a digital photo frame, a mobile internet device, or a GPS device.

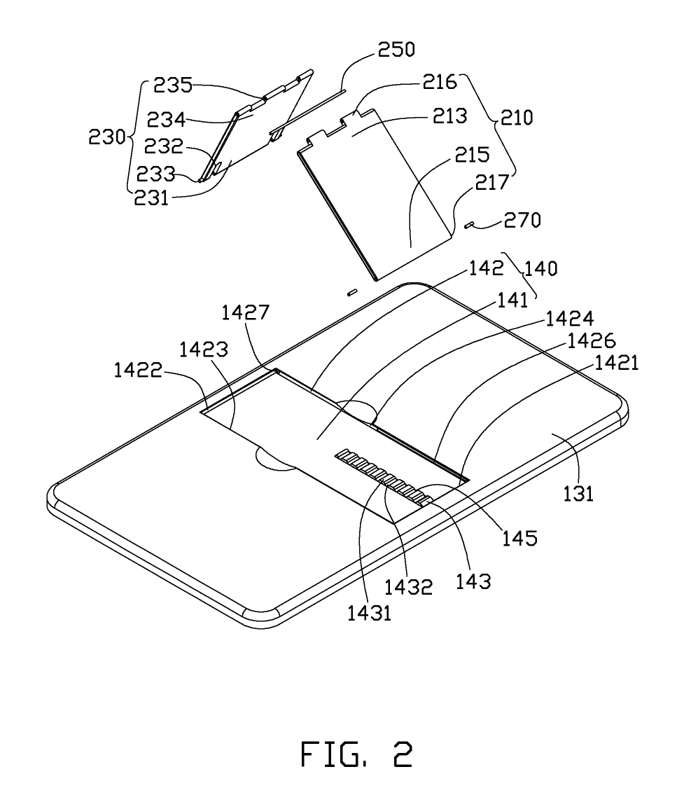

Referring to FIG. 2, the rear housing 130 includes an outer surface 131. The outer surface 131 is partially recesses to define a receiving portion 140 for receiving the table stand 200.

The receiving portion 140 includes a bottom surface 141 and side surfaces 142 surrounding the bottom surface 141. The side surface 142 further includes an upper side 1421, a lower side 1422, a left side 1423 and a right side 1424. At least one of the left side 1423 and the right side 1424 defines a guiding slot 1426. In this embodiment, both the left and the right side 1423 and 1421 define a guiding slot 1426. The receiving portion 140 further defines two pivot holes 1427 at the end of the left side 1423 and the right side 1424 respectively.

A plurality of elastic trapezoidal locking portions 143 protrudes from the bottom surface 141, and is arranged in a line along the longitudinal direction of the receiving portion 140. The trapezoidal retaining portions 143 are parallel with each other, and each two adjacent trapezoidal locking portions 143 define a locking groove 145. The locking groove 145 is used for locking the table stand 200 to prevent the table stand 200 from sliding with respect to the main body 100. The locking portion 143 includes an upper portion 1431 and a lower portion 1432. The upper part 1431 defines a slope which is used for guiding the table stand 200 to insert the locking groove 145 easily. The lower part of the locking part 143 is used for locking the table stand 200 in one of the locking grooves 145. The locking portions 143 are made of elastic material, so that the locking portions 143 can deforms elastically.

The table stand 200 includes a first supporting element 210, a second supporting element 230, a first pivot 250 and at least one retaining pin 270.

The first supporting element 210 is a retaining board which is a substantially rectangular plate. The retaining board 210 includes a first end 213 and a second end 215 opposite to the first end 213. The first end 213 defines two first pivot holes 216. The second end 215 defines at least one second pivot hole 217. Opposite ends of each the retaining pin 270 are respectively received in the second pivot hole 217 and the guiding slot 1426, thus the second end 215 of the retaining board 210 is able to slide in the receiving portion 140.

The second supporting element 230 is a turning board which is a substantially rectangular plate. The turning board 230 includes a third end 231 and a fourth end 234 opposite to the third end 231. The fourth end 234 defines a third pivot hole 235. The first pivot 250 extends through the first pivot holes 216 and the third pivot holes 235 to rotatably connect the turning board 230 with the retaining board 210. Two second pivots 233 are coaxially located respectively at the opposite sides of the third end 231. The third end 231 further defines two openings 232, such that the third end 231 can be deformed. The second pivot 233 inserts in the pivot holes 1427 of the rear housing 130 via the deformation of the third end 232, thus the turning board is capable of rotating with respect to the rear housing 130.

To provide support for the main body 100, the retaining board 210 and the turning board 230 are rotated relative to the main body 100 to a support position. The third end 231 is inserted into the pivot holes 1427 of the receiving portion 140. The retaining pin 270 is slidably received in the guiding slot 1426 such that the second end 215 of the retaining board 210 is received in one of the locking grooves, thus an angle is defined between the retaining board 210 and the turning board 230. As such, the table stand 200 can be fixed and defines an angle with respect to the main body 100.

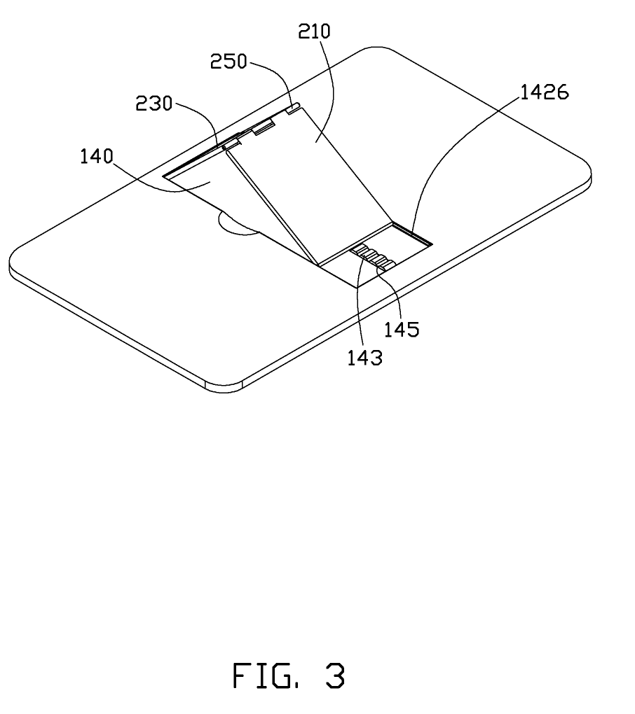

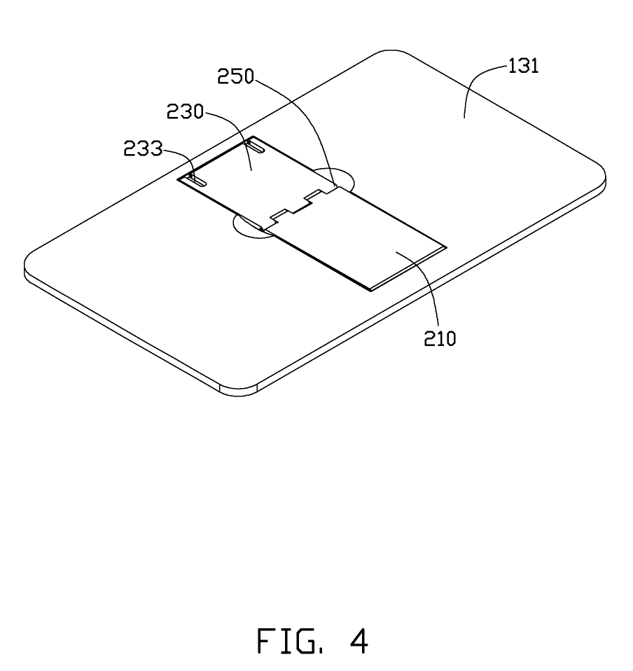

Further referring to FIG. 3, the angle between the table stand 200 and the main body 100 can be adjusted via fixing the second end 215 of the retaining board 210 in a different locking groove 145. The retaining pin 270 moves in the guiding slot 1426 so that the retaining board 210 inserts from one of the locking grooves 145 to another one. Thereby, the main body 100 can be placed at different appropriate viewing angles. Referring to FIG. 4, the table stand 200 can be rotated to be received in the receiving portion 140 if the main body 100 does not need to be supported.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A device, comprising:
a main body with a plurality of locking grooves; and
a table stand rotatably connected to the main body for supporting the main body, the table stand comprising a first portion rotatably connected to the main body and a second portion capable of changing from an inserted position in one of the plurality of locking grooves to another inserted position in another one of the plurality of locking grooves.

2. The device of claim 1, wherein the main body further comprises a receiving portion for receiving the table stand, the table stand is capable of rotating out of the receiving portion to form different angles to place the main body at different appropriate viewing angles.

3. The device of claim 2, wherein the receiving portion comprises a side surface, the side surface defines at least one guiding slot, the second portion is inserted in the guiding slot, so that the first portion is slidable inserted in the pivot holes.

4. The device of claim 2, wherein the table stand further comprises a retaining pin, the second portion defines a first end and a second end, the first end defines two first pivot holes, the second end defines at least one second pivot hole, the first portion, the ends of the retaining pin are received in the second pivot hole and the guiding slot, such that the second portion is inserted in one of the locking grooves.

5. The device of claim 4, wherein the table stand further comprises a first pivot, the first portion comprising a third end and a fourth end, the fourth end defines two third pivot holes, the first pivot extends through the first pivot holes and the second pivot holes to connect the first portion with the second portion.

6. The device of claim 5, wherein the third end defines two openings and two second pivots, the second pivots coaxially located at the opposite sides of the third end and inserted in the pivot holes respectively, such that the first portion is operable to rotate with the main body.

7. The device of claim 1, wherein the main body comprises a front housing and a rear housing engaged with the front housing, the receiving portion is recessed in the rear housing.

8. A device, comprising:
a main body comprising a receiving portion; and
a table stand connected to the main body for supporting the main body; the table stand being received in the receiving portion, the table stand comprising a retaining board and a turning board connected to the retaining board;
wherein the retaining board and the turning board are capable of rotating out of the receiving portion to form different angles to place the main body at different appropriate viewing angles.

9. The device of claim 8, wherein the main body comprising a plurality of locking portions; the adjacent locking portions formed a locking groove, the retaining board inserts to the different locking grooves to change the viewing angles.

10. The device of claim 9, wherein the receiving portion comprises at least one guiding slot, the table stand comprising at least one retaining pin, the ends of the retaining pin are respectively inserted into the guiding slot and the retaining board, such that the retaining board is slidable in the receiving portion.

11. The device of the claim 9, wherein the main body further defines two pivot holes, the turning board defines two second pivots, the second pivots inserted into the pivot holes, such that the first portion rotates with respect to the main body.

12. The device of claim 11, wherein the turning board defines two openings, the flexibly openings pressed toward the retaining board, such that the second pivots are received in the pivot holes.

13. The device of claim 9, wherein each of the locking portions is a trapezoid and parallel with each other, the locking portion comprises a upper portion and a bottom portion.

14. The device of claim 13, wherein the upper portion is used for guiding the retaining board to insert the locking groove.

15. The device of claim 13, wherein the bottom portion is used for locking the retaining board in the locking groove.

16. The device of claim 8, wherein the table stand further comprises a first pivot, the retaining board defines two first pivot holes and at least one second pivot hole, the turning board defines two third pivot holes, the first pivot extend through the first pivot holes and the third pivot holes to rotatably connect the turning board with the retaining board.

17. The device of claim 8, wherein the main body comprises a front housing and a rear housing, the table stand is rotatably connected to the rear housing.

18. An adjustable table stand for supporting a device, comprising:
a first supporting element with a first end and a second end opposite to the first end, the first end being slidably connected to a first location;
a second supporting element with a third end, a fourth end opposite to the third end, the third end being pivotally connected to the second end of the first supporting element, the fourth end being pivotally connected to a second location of the device which is different from the first location; and
a retaining element with a plurality of retaining portions operable to engage with the first end of the first supporting element.

19. The adjustable stable stand of claim 18, wherein the plurality of the retaining portions is arranged in a line along a direction from the first location to the second location of the device.

20. The adjustable stable stand of claim 18, wherein the plurality of retaining portions comprise a plurality of retaining grooves.
